(19) United States
(12) Patent Application Publication
(10) Pub. No.: US 2023/0259845 A1
(43) Pub. Date: Aug. 17, 2023

(54) INFORMATION PROCESSING METHOD AND INFORMATION PROCESSING SYSTEM

(71) Applicant: PANASONIC INTELLECTUAL PROPERTY MANAGEMENT CO., LTD., Osaka (JP)

(72) Inventors: Shinya NISHIKAWA, Osaka (JP); Changhui YANG, Osaka (JP); Atsuyoshi KITA, Osaka (JP)

(21) Appl. No.: 18/002,794

(22) PCT Filed: Jun. 28, 2021
(86) PCT No.: PCT/JP2021/024310

§ 371 Date: Dec. 21, 2022

(30) Foreign Application Priority Data
Jul. 9, 2020 (JP) 2020-118636

(51) Int. Cl. G06Q 10/0631; G06Q 10/047

(52) U.S. Cl. CPC G06Q 10/06315; G06Q 10/047; G08G 1/202

(57) ABSTRACT

An information processing device acquires movement plan information including a total moving distance per unit period of a plurality of movable bodies; acquires relationship information indicating a relationship between a moving distance per the unit period of the movable body and a deterioration degree of the battery; acquires first cost information for calculating a first cost varying with the number of the movable bodies and second cost information for calculating a second cost varying with the deterioration degree of the battery; and determines a planned number of movable bodies, the planned number being the number of the movable bodies for use in a movement plan and being the number of the movable bodies having a total of the first cost and the second cost satisfying a predetermined requirement, on the basis of the movement plan information, the relationship information, the first cost information, and the second cost information.

### TECHNICAL FIELD

The present disclosure relates to an information processing method and an information processing system.

### BACKGROUND ART

Patent Literature 1 below discloses a charge and dispatch planning system that performs charge control and vehicle dispatch control of a plurality of shared electric vehicles.

In the technique disclosed in Patent Literature 1, an unnecessary cost might occur in execution of a plan. For example, since a predetermined number of electric vehicles are used in the technique, a shortage or a surplus of electric vehicles might occur depending on an increase or a decrease in vehicle dispatch demand, and an unnecessary cost might occur.

### CITATION LIST

### Patent Literature

Patent Literature 1: JP 5803547 B

### SUMMARY OF INVENTION

An object of the present disclosure is to provide a technique enabling reduction in cost generated in execution of a movement plan.

An information processing method according to one aspect of the present disclosure includes, by an information processing device: acquiring movement plan information including a total moving distance per unit period of a plurality of movable bodies, the movable body being mounted with a battery for movement; acquiring relationship information indicating a relationship between a moving distance per the unit period of the movable body and a deterioration degree of the battery; acquiring first cost information for calculating a first cost varying with the number of the movable bodies and second cost information for calculating a second cost varying with the deterioration degree of the battery; determining a planned number of movable bodies, the planned number being the number of the movable bodies for use in a movement plan and being the number of the movable bodies having a total of the first cost and the second cost satisfying a predetermined requirement, on the basis of the movement plan information, the relationship information, the first cost information, and the second cost information; and causing a presentation device to present information indicating the planned number of movable bodies.

### BRIEF DESCRIPTION OF DRAWINGS

FIG. 1 is a block diagram illustrating a configuration of an information processing system according to an embodiment of the present disclosure.

FIG. 2 is a block diagram illustrating functions of a data processing unit.

FIG. 3 is a diagram illustrating an example of a long-term business plan of a certain business establishment.

FIG. 4 is a diagram illustrating an example of a current business situation at a certain business establishment.

FIG. 5 is a diagram illustrating an example of business costs at a certain business establishment.

FIG. 6 is a diagram illustrating an example of a deterioration characteristic indicating a deterioration degree of a battery with respect to a travel distance of a vehicle.

FIG. 7 is a flowchart illustrating a flow of processing executed by the data processing unit.

FIG. 8 is a diagram illustrating an example of a presented planned number of vehicles in a simplified manner.

FIG. 9 is a diagram illustrating an example of a presented planned travel distance in a simplified manner.

### DESCRIPTION OF EMBODIMENTS

### Knowledge Underlying Present Disclosure

A product purchased through mail order using the Internet or the like is delivered to a home or the like of a customer by a home delivery agent. The home delivery agent uses a plurality of trucks to deliver a parcel in a delivery area in charge. In the future, an electric vehicle (EV) on which a battery-driven traveling motor is mounted will become widespread, and home delivery agents that deliver parcels by EV trucks is expected to increase in number.

In an EV, a battery deteriorates according to a total travel distance from the time of new car. A state of health (SoH) is generally used as an index indicating a deterioration degree of a battery. When the SoH decreases to, for example, 80% in comparison with an initial value at the time of new car, this EV (or battery) is considered to come to the end of its life, and replacement with a new EV (or battery) is required.

In operating the delivery service using an EV, it is important to formulate a business plan so as to minimize a total cost of ownership (TCO) in a long term (e.g., 10 years) including not only initial costs such as a vehicle purchase cost but also running costs such as a labor cost of drivers and a vehicle maintenance cost.

For example, in a case of expanding a business scale of a certain business establishment with an increase in an amount of parcels, it is necessary to increase a total travel distance of all vehicles per day at the business establishment according to a plan. In order to increase the total travel distance, it is necessary to increase the number of vehicles while maintaining the travel distance per vehicle, or to increase a travel distance per vehicle while maintaining the number of vehicles. In the former case, although progress of deterioration of a battery of each vehicle does not change, the labor cost of drivers and the vehicle maintenance cost increase as the number of vehicles increases. In the latter case, although the labor cost of the drivers and the vehicle maintenance cost do not change, since the deterioration of the battery proceeds with the increase in the travel distance, the vehicle purchase cost increases due to shortening of a replacement cycle of the vehicle. Therefore, it is important to appropriately determine a planned number of vehicles so as to minimize a long-term total cost.

Patent Literature 1 described above discloses a charge and dispatch planning system that performs charge control and vehicle dispatch control of an EV in car sharing of using a plurality of shared EVs. A charge and dispatch planning unit determines vehicle dispatch of an EV so that a battery deterioration cost for an EV having a large battery deterioration degree is minimized. In addition, the charge and dispatch planning unit charges a battery of the EV whose dispatch has been determined, at a charging speed and a charge amount at which the battery deterioration cost is minimized.

However, the technique disclosed in Patent Literature 1 is only for the purpose of suppressing deterioration of a battery, and does not disclose anything from a viewpoint of minimizing a long-term total cost. In addition, in the above technique, since a predetermined number of electric vehicles are used, a shortage or a surplus of electric vehicles might occur depending on an increase or a decrease in vehicle dispatch demand, and an unnecessary cost might occur. For example, in a case of a surplus of electric vehicles, maintenance costs of not operating electric vehicles occur. In addition, in a case of a shortage of the electric vehicles, a battery will be used up to generate a deterioration cost.

In order to solve the above problems, the present inventor has classified long-term total costs into a cost that varies with the number of movable bodies and a cost that varies with a deterioration degree of a battery. Then, the present inventor has acquired knowledge that an optimum planned number of movable bodies can be determined so as to minimize a total long-term cost by using these pieces of cost information, long-term plan information, and information on a deterioration characteristic of a battery with respect to a travel distance, and has arrived at the present disclosure.

Next, each aspect of the present disclosure will be described.

An information processing method according to one aspect of the present disclosure includes, by an information processing device: acquiring movement plan information including a total moving distance per unit period of a plurality of movable bodies, the movable body being mounted with a battery for movement; acquiring relationship information indicating a relationship between a moving distance per the unit period of the movable body and a deterioration degree of the battery; acquiring first cost information for calculating a first cost varying with the number of the movable bodies and second cost information for calculating a second cost varying with the deterioration degree of the battery; determining a planned number of movable bodies, the planned number being the number of the movable bodies for use in a movement plan and being the number of the movable bodies having a total of the first cost and the second cost satisfying a predetermined requirement, on the basis of the movement plan information, the relationship information, the first cost information, and the second cost information; and causing a presentation device to present information indicating the planned number of movable bodies.

According to this configuration, the information processing device determines a planned number of movable bodies such that a sum of the first cost and the second cost satisfies a predetermined requirement on the basis of the movement plan information, the relationship information, the first cost information, and the second cost information. The first cost information is cost information for calculating the first cost that varies with the number of movable bodies. The second cost information is cost information for calculating the second cost that varies with the deterioration degree of the battery. As described above, by determining the planned number of movable bodies on the basis of a total cost of a movable body number-linked cost and a deterioration-linked cost, it is possible to reduce a cost that occurs in execution of the movement plan. For example, it is possible to determine an optimum planned number of movable bodies at which a long-term total cost is minimized. Here, a minimum cost represents a minimum among a plurality of costs that can be calculated. In addition, an optimum planned number of movable bodies represents the number of movable bodies with the minimum cost.

In the above aspect, the method further includes, by the information processing device: in determination of the planned number of movable bodies, determining a planned moving distance that is a moving distance of each of the movable bodies for use in the movement plan and that is a moving distance at which the sum of the first cost and the second cost satisfies the predetermined requirement on the basis of the movement plan information, the relationship information, the first cost information, and the second cost information; and causing the presentation device to present information indicating the planned moving distance.

According to this configuration, the information processing device determines a planned moving distance of each movable body so that the sum of the first cost and the second cost satisfies the predetermined requirement. As described above, by determining a planned travel distance on the basis of the total cost of the movable body number-linked cost and the deterioration-linked cost, it is possible to determine an optimum planned travel distance of each movable body at which a long-term total cost is minimized. Note that an optimum planned distance represents a distance at which the above cost is minimized.

In the above aspect, the method further includes, by the information processing device: in determination of the planned number of movable bodies, determining planned timing that is timing for purchase, sale, or scrapping of each of the movable bodies for use in the movement plan or the battery mounted on each of the movable bodies, the planned timing being timing at which the sum of the first cost and the second cost satisfies the predetermined requirement, on the basis of the movement plan information, the relationship information, the first cost information, and the second cost information; and causing the presentation device to present information indicating the planned timing.

According to this configuration, the information processing device determines planned timing regarding purchase, sale, or scrapping of each movable body or each battery so that the sum of the first cost and the second cost satisfies the predetermined requirement. As described above, by determining planned timing on the basis of the total cost of the movable body number-linked cost and the deterioration-linked cost, it is possible to determine optimum planned timing of each movable body or each battery at which a long-term total cost is minimized. Note that optimum planned timing represents timing when the above cost is minimized.

In the above aspect, the first cost includes at least one of a cost required for maintaining the movable body and a cost required for an operator who operates the movable body.

According to this configuration, accuracy of the first cost, which is the movable body number-linked cost, can be increased by including, in the first cost, at least one of the cost required for maintaining the movable body and the cost required for an operator who operates the movable body.

In the above aspect, the second cost includes a cost for purchase, sale, or scrapping of the battery having the deterioration degree equal to or higher than a threshold or of the movable body on which the battery is mounted.

According to this configuration, accuracy of the second cost, which is the deterioration-linked cost, can be increased by including, in the second cost, the cost for purchase, sale, or scrapping of a battery having the deterioration degree equal to or higher than the threshold or a movable body on which the battery is mounted.

An information processing system according to one aspect of the present disclosure includes: a first acquisition unit that acquires movement plan information including a total moving distance per unit period of a plurality of movable bodies, the movable body being mounted with a battery for movement; a second acquisition unit that acquires relationship information indicating a relationship between a moving distance per the unit period of the movable body and a deterioration degree of the battery; a third acquisition unit that acquires first cost information for calculating a first cost varying with the number of the movable bodies and second cost information for calculating a second cost varying with the deterioration degree of the battery; a determination unit that determines a planned number of movable bodies, the planned number being the number of the movable bodies for use in a movement plan and being the number of the movable bodies having a total of the first cost and the second cost satisfying a predetermined requirement, on the basis of the movement plan information, the relationship information, the first cost information, and the second cost information; and a presentation unit that presents information indicating the planned number of movable bodies.

According to this configuration, the determination unit determines a planned number of movable bodies such that a sum of the first cost and the second cost satisfies a predetermined requirement on the basis of the movement plan information, the relationship information, the first cost information, and the second cost information. The first cost information is cost information for calculating the first cost that varies with the number of movable bodies. The second cost information is cost information for calculating the second cost that varies with the deterioration degree of the battery. As described above, by determining the planned number of movable bodies on the basis of a total cost of a movable body number-linked cost and a deterioration-linked cost, it is possible to reduce a cost that occurs in execution of the movement plan. For example, it is possible to determine an optimum planned number of movable bodies at which a long-term total cost is minimized. Here, a minimum cost represents a minimum among a plurality of costs that can be calculated. In addition, an optimum planned number of movable bodies represents the number of movable bodies with the minimum cost.

The comprehensive or specific aspects of the present disclosure described above can be implemented as a system, a device, a method, an integrated circuit, a computer program, or any combination thereof. It is needless to say that such a computer program can be distributed using a computer-readable non-volatile recording medium such as a CD-ROM, or via a communication network such as the Internet.

Each of embodiments to be described below illustrates a specific example of the present disclosure. Numerical values, shapes, components, steps, order of steps, and the like shown in the following embodiments are merely examples, and are not intended to limit the present disclosure. Among components in the following embodiments, a component that is not described in an independent claim indicating the most significant concept will be described as an arbitrary component. All the embodiments have respective contents that can be combined.

### Embodiment of Present Disclosure

In the following, embodiments of the present disclosure will be described in detail with reference to the drawings. Note that elements denoted by the same reference numerals in different drawings represent the same or corresponding elements.

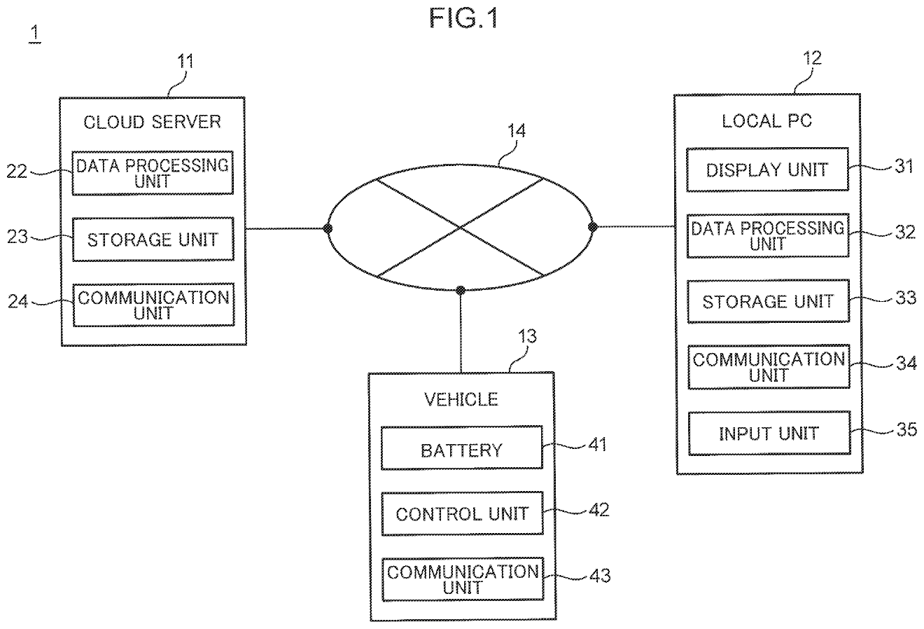

FIG. 1 is a block diagram illustrating a configuration of an information processing system 1 according to an embodiment of the present disclosure. In an example of the present embodiment, the information processing system 1 is constructed as a management system of a home delivery agent that delivers a parcel to a customer's home or the like by an electric vehicle (EV). As an example, the home delivery agent owns a plurality of business establishments each in charge of each delivery area and a head office that controls the plurality of business establishments. A local PC12 is installed in the head office and each business establishment, and is connected to a cloud server 11. In addition, a plurality of vehicles 13 for parcel delivery is arranged in each business establishment. The cloud server 11, the local PC12, and the vehicle 13 are communicable with each other via an arbitrary communication network 14 such as an IP network. Although in the above embodiment, the movable body is a vehicle, the present disclosure is not limited thereto. The movable body may be an aircraft such as a drone, a ship, or a mobile robot.

The cloud server 11 includes a data processing unit 22, a storage unit 23, and a communication unit 24. The local PC12 includes a display unit 31, a data processing unit 32, a storage unit 33, a communication unit 34, and an input unit 35. The display unit 31 is a liquid crystal display, an organic EL display, or the like. The data processing units 22 and 32 are processors such as CPUs. The storage units 23 and 33 are HDDs, SSDs, or the like. The communication units 24 and 34 are communication modules that perform data communication according to a predetermined communication standard such as IP. The input unit 35 is a mouse, a keyboard, or the like.

The vehicle 13 is an EV truck or the like, and includes a battery 41, a control unit 42, and a communication unit 43. The battery 41 is a secondary battery such as a lithium ion battery for driving a traveling motor mounted on the vehicle 13. The control unit 42 is a battery management system (BMS) for performing operation control and state management of the battery 41. The communication unit 43 is a communication module that performs data communication according to a predetermined communication standard such as IP.

Note that an application target of the information processing system 1 according to the present embodiment is not limited to home delivery business, and is any business such as taxi business, car rental business, car sharing business, or chauffeur service that conducts business using a plurality of EVs.

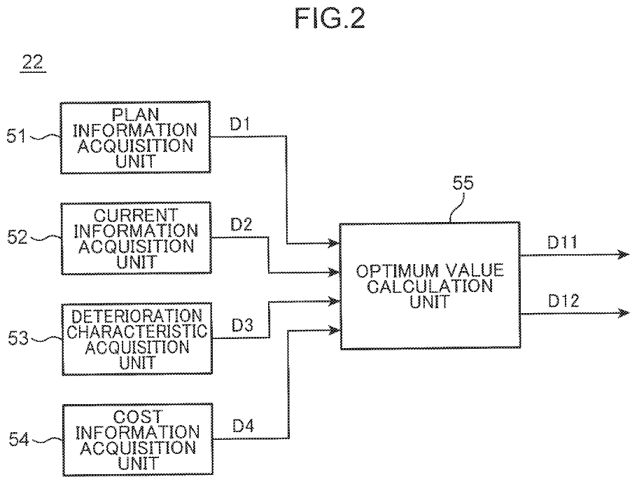

FIG. 2 is a block diagram illustrating functions of the data processing unit 22 of the cloud server 11. As illustrated in FIG. 2, the data processing unit 22 has a plan information acquisition unit 51, a current information acquisition unit 52, a deterioration characteristic acquisition unit 53, a cost information acquisition unit 54, and an optimum value calculation unit 55. These functions may be realized in a software manner by execution, by a CPU, of a program read from a ROM or the like.

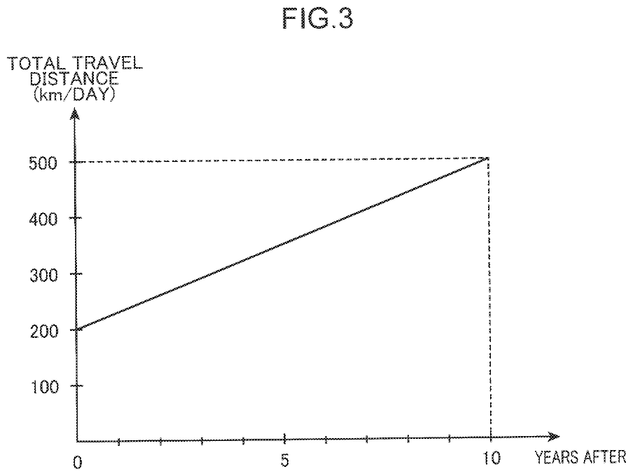

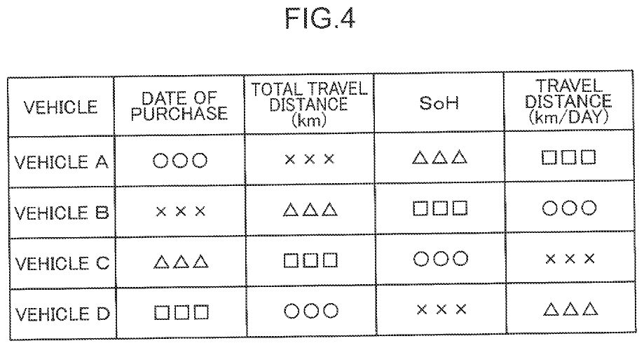

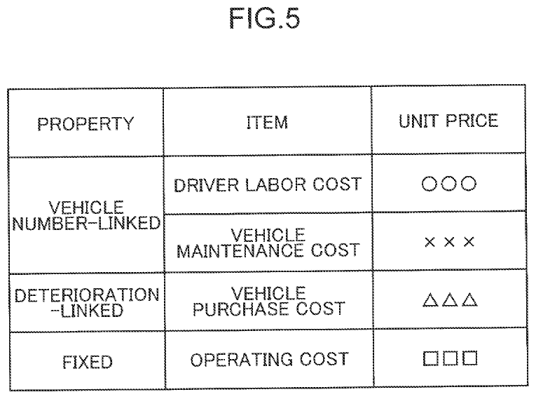

FIG. 3 is a diagram illustrating an example of a long-term business plan of a certain business establishment, FIG. 4 is a diagram illustrating an example of a current business situation at the business establishment, and FIG. 5 is a diagram illustrating an example of business costs at the business establishment.

At present (after zero year), this business establishment is in charge of a predetermined delivery area using four EVs (vehicles A to D). A total travel distance of the four EVs per day is 200 km. In this business establishment, expansion of the business scale is planned with an increase in the amount of parcels, and as shown in FIG. 3, it is planned to increase the total travel distance per day to 500 km after ten years. Plan information indicating the long-term business plan is input from the input unit 35 of the local PC12 installed in the business establishment. The plan information is input to the local PC12 when a new long-term business plan is formulated and when an existing long-term business plan is changed due to occurrence of a special event such as disaster. The input plan information is transmitted from the local PC12 to the cloud server 11 via the communication network 14 and stored in the storage unit 23. With reference to FIG. 2, the plan information acquisition unit 51 acquires the plan information received from the local PC12.

As illustrated in FIG. 4, the current business situation includes date of purchase, a total travel distance from the time of a new car to the present, a current SoH, and a current set value of a travel distance per day for each of four EVs. Current information indicating a current business situation is input from the input unit 35 of the local PC12 installed in the business establishment. The current information is input to the local PC12 when a new long-term business plan is formulated, when an existing long-term business plan is changed, and periodically (e.g., once every half year). The input current information is transmitted from the local PC12 to the cloud server 11 via the communication network 14 and stored in the storage unit 23. In a case of starting up a new business establishment using only a new EV car, since the battery 41 is not deteriorated in any vehicle 13, transmission of current information to the cloud server 11 may be omitted. With reference to FIG. 2, current information acquisition unit 52 acquires the current information received from the local PC12.

As illustrated in FIG. 5, business costs at the business establishment are classified into a cost (vehicle number-linked cost) that varies with the number of the vehicles 13 arranged in the business establishment, a cost (deterioration-linked cost) that varies with a deterioration degree of the battery 41, and a cost (fixed cost) that does not vary with the number of vehicles and the deterioration degree of the battery. The vehicle number-linked cost includes a labor cost of a driver who drives the vehicle 13 (an example of an operator who operates a movable body) and a vehicle maintenance cost such as a maintenance cost and an insurance premium. When the vehicle 13 is an autonomous movable body, the labor cost of a driver is not included. Although not illustrated in FIG. 5, the vehicle number-linked cost includes an electric bill of the vehicle 13, a lease cost of the vehicle 13 when the vehicle is leased, and the like. The deterioration-linked cost includes a vehicle purchase cost of the vehicle 13. In a case where an old vehicle is sold at the time of purchase of a new vehicle, a profit from the sale is counted as a negative vehicle purchase cost. Although not illustrated in FIG. 5, the deterioration-linked cost includes a vehicle scrapping cost for scrapping the vehicle 13 that has come to the end of its life. The fixed cost includes operating costs such as rent, a warehouse cost, and a labor cost excluding the driver. The cost information of the business establishment indicates a cost unit price corresponding to each cost item such as the driver labor cost and the vehicle maintenance cost.

The cost information of the business establishment is input from the input unit 35 of the local PC12 installed in the business establishment. The cost information is input to the local PC12 when a new long-term business plan is formulated, when an existing long-term business plan is changed, and periodically (e.g., once every half year). The input cost information is transmitted from the local PC12 to the cloud server 11 via the communication network 14 and stored in the storage unit 23. Referring to FIG. 2, the cost information acquisition unit 54 acquires the cost information received from the local PC 12.

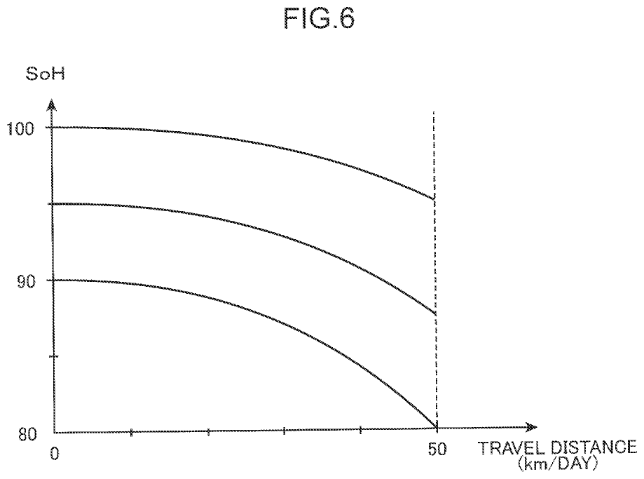

FIG. 6 is a diagram illustrating an example of a deterioration characteristic indicating the deterioration degree of the battery 41 with respect to a travel distance of the vehicle 13. The horizontal axis of the graph represents a travel distance (km/day) per day. The vertical axis of the graph represents a value (%) of SoH after one year in a case where the travel distance indicated by the horizontal axis is continued for one year. The value on the vertical axis when the horizontal axis is 0 is the current SoH of the battery 41. For example, if the battery 41 having the current SoH of 90% is continuously used at a travel distance of 50 km per day, the SoH of that battery 41 drops to 80% after one year. When the SoH of the battery 41 decreases to less than a predetermined value (e.g., 80%) (in other words, when the deterioration degree of the battery 41 becomes equal to or higher than a threshold value), the battery 41 or the vehicle 13 on which the battery 41 is mounted has come to the end of its life.

Although FIG. 6 illustrates deterioration characteristics of only three patterns with the current SoH of 90, 95, and 100%, a large number of deterioration characteristics may be prepared with finer increments (e.g., increment of 1%). In addition, the deterioration characteristic may be indicated in a form such as a function formula or a table instead of the form of such a graph as illustrated in FIG. 6. With reference to FIG. 2, the deterioration characteristic acquisition unit 53 acquires the deterioration characteristic of the battery 41 by reading a deterioration characteristic prepared in advance for each type of the battery from the storage unit 23. Note that the deterioration characteristic acquisition unit 53 may acquire the deterioration characteristic of the battery 41 by acquiring information on the deterioration characteristics from a manufacturer of the battery 41, an analysis manufacturer, or the like. In a case where no deterioration characteristic of the battery 41 is prepared in advance and is available from a manufacturer or the like, the deterioration characteristic acquisition unit 53 acquires the deterioration characteristic of the battery 41 by preparing the deterioration characteristic by itself by analyzing vehicle information (including charge/discharge information of the battery 41) acquired from a large number of vehicles 13.

On the basis of the information illustrated in FIGS. 3 to 6, the cloud server 11 determines an optimum number of vehicles 13 (a planned number of vehicles) to be arranged in each business establishment, and an optimum travel distance of each vehicle 13 (planned travel distance) so that the total cost of ownership (TCO) in a long term (e.g., ten years) at each business establishment is minimized.

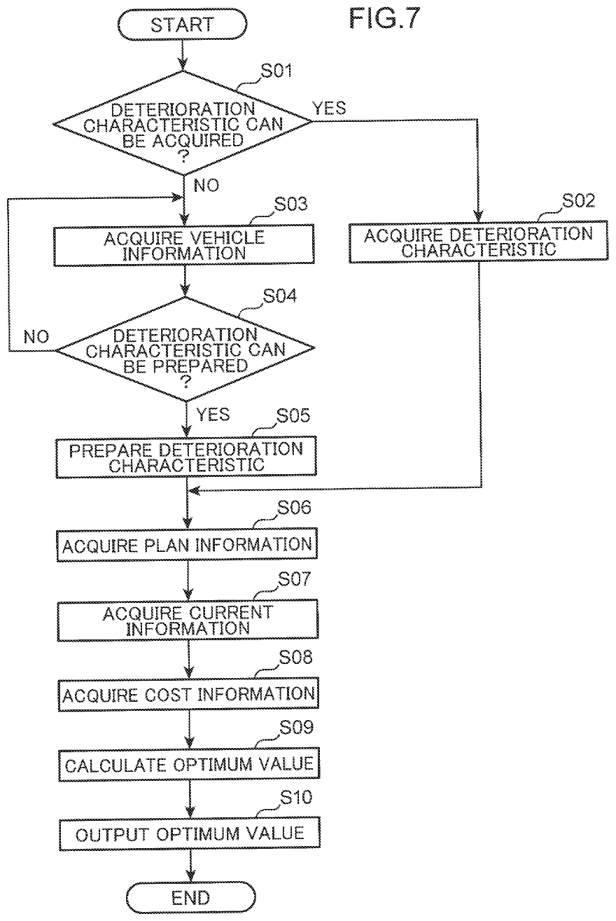

FIG. 7 is a flowchart illustrating a flow of processing executed by the data processing unit 22 of the cloud server 11 to determine a planned number of vehicles and a planned travel distance in a target business establishment.

When a request for determining a planned number of vehicles and a planned travel distance for a certain target business establishment is input to the cloud server 11, first, in Step S01, the deterioration characteristic acquisition unit 53 determines whether or not the deterioration characteristics illustrated in FIG. 6 can be acquired. When the deterioration characteristic prepared in advance is stored in the storage unit 23, or when information on the deterioration characteristic is available from a manufacturer of the battery 41 or the like, the deterioration characteristic acquisition unit 53 determines that the deterioration characteristic can be acquired.

When the deterioration characteristic can be acquired (Step S01: YES), next in Step S02, the deterioration characteristic acquisition unit 53 acquires the deterioration characteristic of the battery 41 by reading the deterioration characteristic from the storage unit 23 or by accessing a database of a manufacturer of the battery 41 or the like and downloading the information on the deterioration characteristic. The deterioration characteristic acquisition unit 53 inputs the acquired deterioration characteristic to the optimum value calculation unit 55 as data D3.

In a case where the deterioration characteristic cannot be acquired (Step S01: NO), the cloud server 11 then acquires the vehicle information from a large number of vehicles 13 via the communication network 14 in Step S03. The vehicle information includes the charge/discharge information of the battery 41 of each vehicle 13. The vehicle information also includes travel distance information of each vehicle 13. The acquired vehicle information is accumulated in the storage unit 23.

Next, in Step S04, the deterioration characteristic acquisition unit 53 determines whether or not a sufficient amount of the vehicle information for preparing the deterioration characteristic has been accumulated in the storage unit 23. In a case where a sufficient amount of the vehicle information is not accumulated (Step S04: NO), the processing of Steps S03 and S04 is repeatedly executed until a sufficient amount of the vehicle information is accumulated.

When a sufficient amount of vehicle information has been accumulated (Step S04: YES), next, in Step S05, the deterioration characteristic acquisition unit 53 prepares the deterioration characteristics of the battery 41 on the basis of the vehicle information accumulated in the storage unit 23. The vehicle information includes the charge/discharge information of the battery 41 and the travel distance information regarding each vehicle 13. Accordingly, by analyzing these pieces of information, the deterioration characteristic acquisition unit 53 can prepare the deterioration characteristic indicating the relationship between the travel distance of the vehicle 13 and the deterioration degree (SoH) of the battery 41 for each type of the battery 41. The deterioration characteristic acquisition unit 53 inputs the prepared deterioration characteristic to the optimum value calculation unit 55 as the data D3.

Subsequently to Step S02 or Step S05, in Step S06, the plan information acquisition unit 51 reads the plan information received from the local PC12 and stored in the storage unit 23 from the storage unit 23, thereby acquiring plan information indicating a long-term business plan of the target business establishment. As illustrated in FIG. 3, the plan information indicates a total travel distance (km/day) per day by a plurality of vehicles 13 arranged at the business establishment on a one year basis. The plan information acquisition unit 51 inputs the acquired plan information to the optimum value calculation unit 55 as data D1.

Next, in Step S07, the current information acquisition unit 52 reads the current information received from the local PC12 and stored in the storage unit 23 from the storage unit 23, thereby acquiring the current information (see FIG. 4) indicating the current business situation of the target business establishment. The current information acquisition unit 52 inputs the acquired current information to the optimum value calculation unit 55 as data D2.

Next, in Step S08, the cost information acquisition unit 54 reads the cost information received from the local PC12 and stored in the storage unit 23 from the storage unit 23, thereby acquiring the cost information of the target business establishment. As illustrated in FIG. 5, the cost information includes the items of the vehicle number-linked costs that vary with the number of vehicles 13 and a unit price for calculating each item (first cost information), the item of the deterioration-linked cost that varies with the deterioration degree of the battery 41 and a unit price for calculating the item (second cost information), and the item of the fixed cost and a unit price for calculating the item. The cost information acquisition unit 54 inputs the acquired cost information to the optimum value calculation unit 55 as data D4.

Next, in Step S09, the optimum value calculation unit 55 determines a planned number of the vehicles 13 and a planned travel distance of each vehicle 13 for the target business establishment on the basis of the deterioration characteristic indicated by the data D3, the plan information indicated by the data D1, the current information indicated by the data D2, and the cost information indicated by the data D4. A prediction model for predicting objective variables (a planned number of vehicles, a planned travel distance) from explanatory variables (deterioration characteristic, plan information, current information, cost information) can be derived by machine learning using artificial intelligence. As an algorithm of the prediction model, path optimization by linear programming, a neural network, multiple regression analysis, or the like can be used. A combination of the number of vehicles and a travel distance of each vehicle for realizing a total travel distance in each year specified in the plan information is variously changed to search for a combination in which the TCO satisfies a predetermined requirement. As the predetermined requirement, for example, one combination in which the TCO is minimized or one or more combinations in which the TCO is less than a target value are searched for. The optimum value calculation unit 55 outputs the determined planned number of vehicles as data D11, and outputs the determined planned travel distance as data D12.

Next, in Step S10, the cloud server 11 transmits the data D11 and D12 to the local PC12 of the head office or the target business establishment via the communication network 14. The display unit 31 of the local PC12 displays (presents) the planned number of vehicles and the planned travel distance regarding its own business establishment on the basis of the received data D11 and D12.

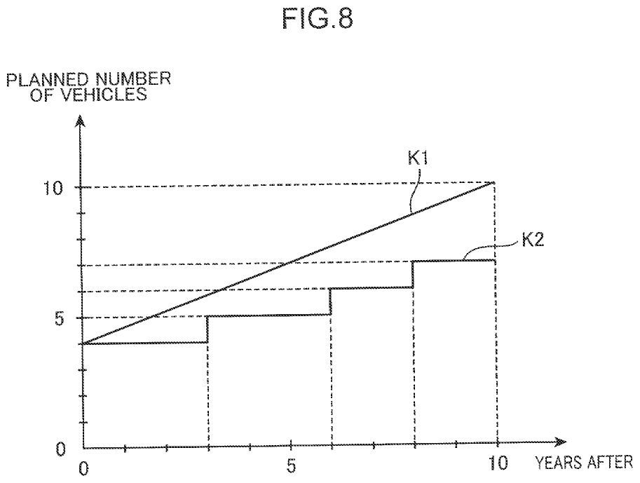

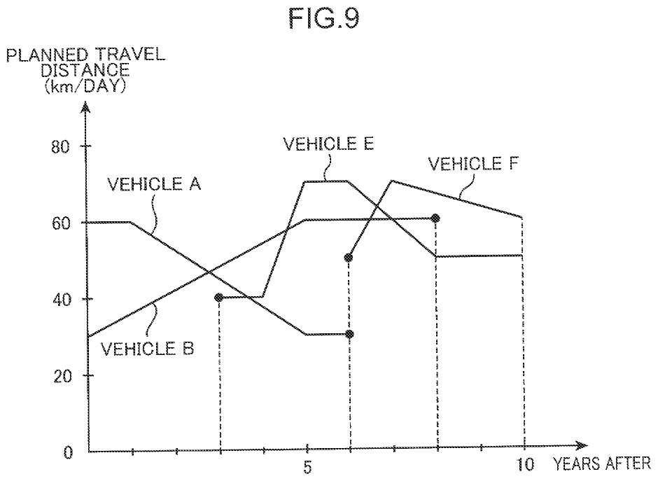

FIG. 8 is a diagram illustrating an example of a presented planned number of vehicles in a simplified manner, and FIG. 9 is a diagram illustrating an example of the presented planned travel distance in a simplified manner. In FIG. 8, a characteristic K1 indicates a graph in a case where the number of the vehicles 13 is simply increased in accordance with an increase in the total travel distance. The number of vehicles 13 after ten years is ten. A characteristic K2 indicates a progression of the planned number of vehicles determined by the optimum value calculation unit 55. The number of the vehicles 13 increases one by one after three years, six years, and eight years, and the number of the vehicles 13 after ten years is seven.

With reference to FIG. 9, it can be seen that the planned travel distance greatly increases or decreases every year even regarding the same vehicle 13 (e.g., a vehicle E). In addition, for example, the graph regarding the vehicle A disappears after six years. This indicates that the optimum time for selling (or scrapping) the vehicle A is after six years. Further, a graph regarding the vehicle E appears after three years. This indicates that the optimum timing for purchasing the vehicle E is three years later.

In a case of the vehicle 13 whose battery 41 is replaceable, replacement timing of the battery 41 may be presented. For example, when the battery 41 of the vehicle A is replaced six years later, a graph of a vehicle F is taken over by the vehicle A whose battery has been replaced.

According to the present embodiment, the cloud server 11 (an information processing device) determines a planned number of vehicles 13 (movable bodies) on the basis of the plan information (movement plan information) indicated by the data D1, the deterioration characteristic (relationship information) indicated by the data D3, and the cost information (the first cost information and the second cost information) indicated by the data D4 so that the TCO satisfies a predetermined requirement. The first cost information is cost information for calculating the vehicle number-linked cost (the first cost) that varies with the number of the vehicles 13. The second cost information is cost information for calculating the deterioration-linked cost (the second cost) that varies with the deterioration degree of the battery 41. As described above, by determining the planned number of movable bodies on the basis of a total cost of a movable body number-linked cost and a deterioration-linked cost, it is possible to reduce a cost that occurs in execution of the movement plan. For example, it is possible to determine an optimum planned number of the vehicles 13 at which a long-term total cost is minimized.

Furthermore, according to the present embodiment, in determining a planned number of vehicles, the cloud server 11 determines a planned travel distance of each vehicle 13 so that the TCO satisfies a predetermined requirement. As described above, by determining a planned travel distance on the basis of the total cost of the vehicle number-linked cost and the deterioration-linked cost, it is possible to determine an optimum planned travel distance of each vehicle 13 at which a long-term total cost is minimized.

Furthermore, according to the present embodiment, in the determination of a planned number of vehicles, the cloud server 11 determines planned timing regarding purchase, sale, or scrapping of the vehicle 13 (or the battery 41) so that TCO satisfies the predetermined requirement. As described above, by determining planned timing on the basis of the total cost of the vehicle number-linked cost and the deterioration-linked cost, it is possible to determine optimum planned timing of the vehicle 13 or the battery 41 at which a long-term total cost is minimized.

Furthermore, according to the present embodiment, accuracy of the first cost, which is the vehicle number-linked cost, can be increased by including, in the first cost, at least one of the cost required for maintaining the vehicle 13 (vehicle maintenance cost) and the cost required for a driver that drives the vehicle 13 (driver labor cost).

In addition, according to the present embodiment, accuracy of the second cost, which is the deterioration-linked cost, can be increased by including, in the second cost, the cost for purchase, sale, or scrapping of the battery 41 whose deterioration degree is equal to or higher than the threshold or the vehicle 13 on which the battery 41 is mounted (vehicle purchase cost).

### INDUSTRIAL APPLICABILITY

The technique according to the present disclosure is particularly useful for formulating a long-term business plan in home delivery business or the like using a plurality of EVs.

1. An information processing method comprising, by an information processing device:
acquiring movement plan information including a total moving distance per unit period of a plurality of movable bodies, the movable body being mounted with a battery for movement;
acquiring relationship information indicating a relationship between a moving distance per the unit period of the movable body and a deterioration degree of the battery;
acquiring first cost information for calculating a first cost varying with the number of the movable bodies and second cost information for calculating a second cost varying with the deterioration degree of the battery;
determining a planned number of movable bodies, the planned number being the number of the movable bodies for use in a movement plan and being the number of the movable bodies having a total of the first cost and the second cost satisfying a predetermined requirement, on the basis of the movement plan information, the relationship information, the first cost information, and the second cost information; and
causing a presentation device to present information indicating the planned number of movable bodies.

2. The information processing method according to claim 1, further comprising, by the information processing device:
in determination of the planned number of movable bodies, determining a planned moving distance that is a moving distance of each of the movable bodies for use in the movement plan and that is a moving distance at which the sum of the first cost and the second cost satisfies the predetermined requirement on the basis of the movement plan information, the relationship information, the first cost information, and the second cost information; and
causing the presentation device to present information indicating the planned moving distance.

3. The information processing method according to claim 1, further comprising, by the information processing device:
in determination of the planned number of movable bodies, determining planned timing that is timing for purchase, sale, or scrapping of each of the movable bodies for use in the movement plan or the battery mounted on each of the movable bodies, the planned timing being timing at which the sum of the first cost and the second cost satisfies the predetermined requirement, on the basis of the movement plan information, the relationship information, the first cost information, and the second cost information; and
causing the presentation device to present information indicating the planned timing.

4. The information processing method according to claim 1, wherein the first cost includes at least one of a cost required for maintaining the movable body and a cost required for an operator who operates the movable body.

5. The information processing method according to claim 1, wherein the second cost includes a cost for purchase, sale, or scrapping of the battery having the deterioration degree equal to or higher than a threshold or of the movable body on which the battery is mounted.

6. An information processing system comprising:
a first acquisition unit that acquires movement plan information including a total moving distance per unit period of a plurality of movable bodies, the movable body being mounted with a battery for movement;
a second acquisition unit that acquires relationship information indicating a relationship between a moving distance per the unit period of the movable body and a deterioration degree of the battery;
a third acquisition unit that acquires first cost information for calculating a first cost varying with the number of the movable bodies and second cost information for calculating a second cost varying with the deterioration degree of the battery;
a determination unit that determines a planned number of movable bodies, the planned number being the number of the movable bodies for use in a movement plan and being the number of the movable bodies having a total of the first cost and the second cost satisfying a predetermined requirement, on the basis of the movement plan information, the relationship information, the first cost information, and the second cost information; and
a presentation unit that presents information indicating the planned number of movable bodies.
